(19) United States
(12) Patent Application Publication
(10) Pub. No.: US 2025/0328707 A1
(43) Pub. Date: Oct. 23, 2025

(54) COMPRESSOR TEMPERATURE ESTIMATION METHOD

(71) Applicant: HYUNDAI MOBIS CO., LTD., Seoul (KR)

(72) Inventors: Cheol Joong KIM, Suwon-si (KR); Seong Won LEE, Hwaseong-si (KR)

(73) Assignee: HYUNDAI MOBIS CO., LTD., Seoul (KR)

(21) Appl. No.: 19/073,150

(22) Filed: Mar. 7, 2025

(30) Foreign Application Priority Data
Apr. 22, 2024 (KR) 10-2024-0053446

(51) Int. Cl. G06F 30/20; G06F 111/10; G06F 119/08

(52) U.S. Cl. CPC G06F 30/20; G06F 2111/10; G06F 2119/08

(57) ABSTRACT

Disclosed is a method of estimating a compressor temperature. The method includes: calculating a compressor state temperature estimate based on operating status of the compressor, vehicle speed, and compressor pressure; and calculating a compressor temperature estimate by adding the ambient temperature to the compressor state temperature estimate.

### CROSS-REFERENCE TO RELATED APPLICATIONS

This application is based on and claims priority under 35 U.S.C. 119 to Korean Patent Application No. 10-2024-0053446, filed on Apr. 22, 2024, in the Korean Intellectual Property Office, the disclosure of which is herein incorporated by reference in its entirety.

### TECHNICAL FIELD

The present disclosure relates to a technology for estimating the temperature of a compressor that compresses air.

### BACKGROUND

A compressor is a device that compresses air using a power source such as a motor and functions as a pneumatic source that supplies pneumatic pressure to various devices utilizing pneumatic pressure.

A vehicle may be equipped with various devices that use pneumatic pressure. For example, in the case of a vehicle equipped with an air suspension, the compressor is configured to generate and supply pneumatic pressure to air springs arranged between respective wheels and the vehicle body.

The foregoing described as the background art is intended merely to aid in the understanding of the background of the present disclosure, and is not intended to mean that the present disclosure falls within the purview of the related art already known to those skilled in the art.

### SUMMARY

The present disclosure provides a compressor temperature estimation method that allows the temperature of a compressor installed in a vehicle to be appropriately estimated without using a separate temperature sensor to prevent the compressor from overheating, thereby reducing the manufacturing cost of the compressor assembly, and sufficiently ensuring the durability of the compressor.

In view of the foregoing, a compressor temperature estimation method of the present disclosure includes: defining a difference between the compressor temperature and an ambient temperature as a compressor state temperature; calculating a compressor state temperature estimate based on operating status of the compressor, vehicle speed, and compressor pressure; and calculating a compressor temperature estimate by adding the ambient temperature to the compressor state temperature estimate.

In the calculating the compressor state temperature estimate, the compressor state temperature estimate may be calculated by using an estimator state equation that defines the compressor state temperature estimate and a compressor pressure estimate as state variable estimates, takes the operating status of the compressor as an input, and adds a compressor pressure estimation error.

The estimator state equation is expressed as: \hat{\dot{x}}=A\hat{x}+Bu+L(y−ŷ).

Here, state variable is

$$x = [ \begin{matrix}{T}_{c} \\ P\end{matrix} ] ,$$

state variable estimate is

$$\hat{x} = [ \begin{matrix}{\hat{T}}_{c} \\ \hat{P}\end{matrix} ] ,$$

time derivative of state variable estimate is

$$\dot{\hat{x}} = \frac{d \hat{x}}{dt} ,$$

T_{c} is compressor state temperature, Î_{c} is compressor state temperature estimate, P is compressor pressure, \hat{P} is compressor pressure estimate, u is compressor operation signal, y=P, ŷ=\hat{P}, (y−ŷ) is compressor pressure estimate error, system matrix is

$$A = [ \begin{matrix}{a}_{1} + {a}_{2} {V}_{s} & {a}_{3} \\ {a}_{4} & {a}_{5}\end{matrix} ] ,$$

input matrix is

$$B = [ \begin{matrix}{b}_{1} \\ {b}_{2}\end{matrix} ] ,$$

Vₛ is vehicle speed, and L is estimate gain.

The compressor pressure P may be obtained by a pressure sensor configured to measure the pressure at an outlet side of the compressor.

Characteristic parameters a1, a2, a3, a4, and a5 of the system matrix A and characteristic parameters b1 and b2 of the input matrix B are set to values that minimize a model error [temperature sensor temperature-compressor temperature estimate] by using a compressor temperature model below.

$$Temperature model = \{ \begin{matrix}[ \begin{matrix}{\dot{T}}_{c} \\ \dot{P}\end{matrix} ] = [ \begin{matrix}{a}_{1} + {a}_{2} {V}_{s} & {a}_{3} \\ {a}_{4} & {a}_{5}\end{matrix} ] [ \begin{matrix}{T}_{c} \\ P\end{matrix} ] + [ \begin{matrix}{b}_{1} \\ {b}_{2}\end{matrix} ] u \\ {T}_{e} = {T}_{c} + {T}_{o} \\ {\hat{T}}_{e} = {\hat{T}}_{c} + {\hat{T}}_{o} \\ y = P\end{matrix}$$

Here, Tₑ is compressor temperature=temperature sensor temperature, \hat{T}ₑ is compressor temperature estimate, and Tₒ is ambient temperature.

The characteristic parameter a2 of the system matrix A may be set to a negative value to reflect the temperature decrease of the compressor according to the vehicle speed, and a1 may be set to reflect the temperature decrease of the compressor when the vehicle is stationary.

The estimate gain L may be classified into four different categories based on the state of the compressor, and a separate estimate gain may be used for each state.

The four states of the compressor, for which the classified estimate gains are used, respectively, may include: a state in which the compressor is operated to store compressed air in a reservoir; a state in which the operation of the compressor is stopped after storing compressed air in the reservoir, and the temperature of the compressor decreases; a state in which the compressor is operated to supply compressed air to a load; and a state in which the operation of the compressor is stopped after supplying compressed air to the load, and the temperature of the compressor decreases.

A load receiving the compressed air from the compressor may be an air spring of an air suspension.

According to the present disclosure, it is possible to estimate the temperature of a compressor installed in a vehicle to be appropriately estimated without using a separate temperature sensor to prevent the compressor from overheating, thereby reducing the manufacturing cost of the compressor assembly, and sufficiently ensuring the durability of the compressor.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram exemplifying an air suspension system of a vehicle to which a compressor temperature estimation method according to the present disclosure is applicable;

FIG. 2 is a block diagram representing the compressor temperature estimation method according to the present disclosure;

FIG. 3 is a diagram illustrating the block diagram of FIG. 2 in a more simplified manner; and

FIG. 4 is a graph comparing a compressor temperature estimate estimated by the compressor temperature estimation method according to the present disclosure with a temperature sensor measurement value.

### DETAILED DESCRIPTION

Hereinafter, embodiments set forth herein will be described in detail with reference to the accompanying drawings, and the same or similar elements are given the same and similar reference numerals regardless of figure numbers, so duplicate descriptions thereof will be omitted.

The terms “module” and “unit” used for the elements in the following description are given or interchangeably used in consideration of only the ease of writing the specification, and do not have distinct meanings or roles by themselves.

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

A singular expression includes a plural expression unless they are definitely different in the context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

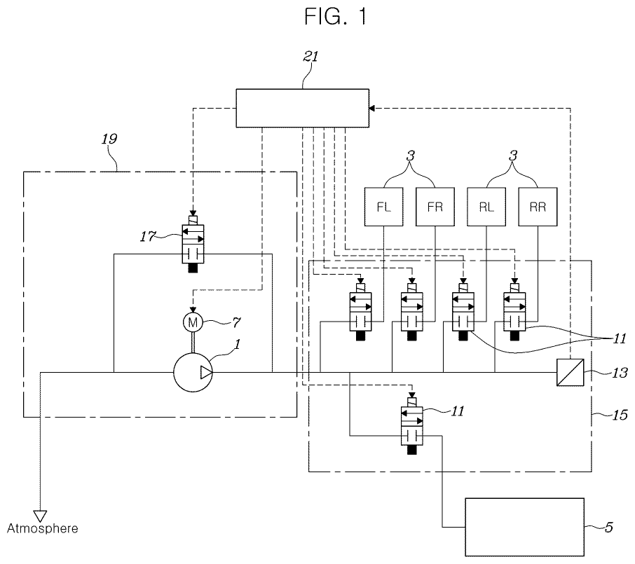

FIG. 1 exemplifies an air suspension system of a vehicle to which a compressor temperature estimation method according to the present disclosure is applicable. The compressor 1 compresses the air to be supplied to air springs 3, and the compressed air may also be stored in a reservoir 5.

The compressor 1 is driven by a motor 7 to intake, compress, and discharge air, and is configured to selectively supply the air to the air springs 3 installed at the front, rear, left, and right sides of the vehicle through multiple control valves 11. The reservoir 5 is also configured to control the inflow and outflow of the compressed air through the control valves 11.

A pressure sensor 13 is provided on the discharge side of the compressor 1 to measure the pressure of the compressed air output by the compressor 1, and the ‘compressor pressure’, which will be described later, refers to the pressure measured by this pressure sensor 13.

The control valves 11 and the pressure sensor 13 may be assembled into an integrated valve block 15, and a compressor assembly 19 may include the compressor, the motor 7, and a discharge valve 17 that connects the discharge side of the compressor 1 to the intake side.

In addition, the control valves 11, the discharge valve 17, and the motor 7 are configured to be controlled by a controller 21.

Incidentally, the present disclosure may ultimately be used to ensure durability by preventing the motor 7 that drives the compressor 1 from overheating. Since the motor 7 is assembled almost integrally and adjacent to the compressor 1, the ‘compressor temperature’, which will be described later, may be interpreted as essentially referring to the temperature of the motor 7 that drives the compressor 1.

Meanwhile, the difference between the compressor temperature and the ambient temperature will be referred to as a ‘compressor state temperature’.

Since the compressor temperature will ultimately converge to the ambient temperature over time in the state in which the operation of the compressor 1 is halted, the term ‘compressor state temperature’ is used to distinguish and express the temperature changes of the compressor based on the operation status of the compressor 1, using the compressor temperature measured by the temperature sensor.

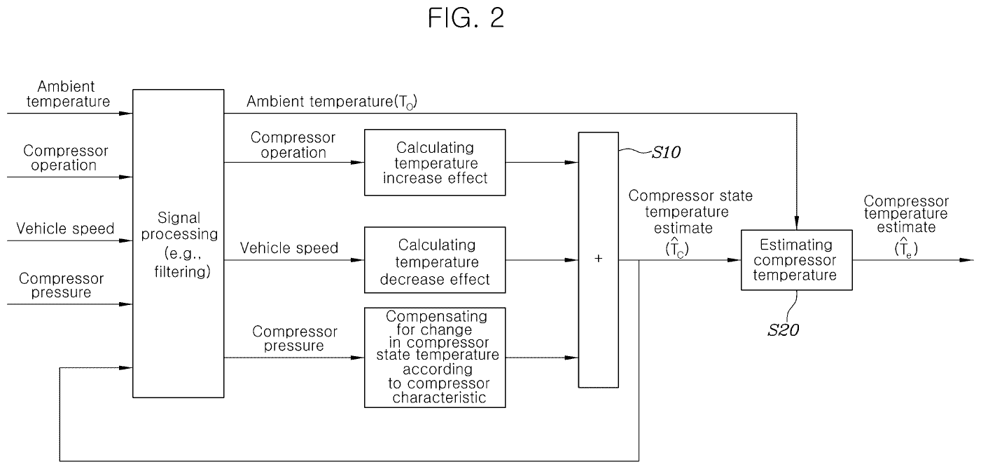

Referring to FIG. 2, an embodiment of the compressor temperature estimation method according to the present disclosure includes: calculating a compressor state temperature estimate based on the operating status of the compressor, the vehicle speed, and the compressor pressure (S10); and calculating a compressor temperature estimate by adding the ambient temperature to the compressor state temperature estimate (S20).

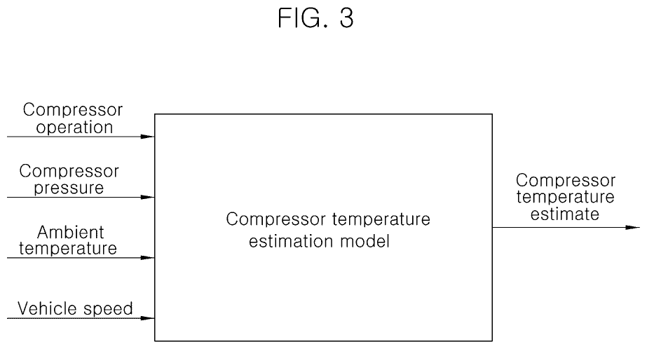

That is, the present disclosure, without using a separate temperature sensor, ultimately calculates the compressor temperature estimate by receiving information regarding the compressor operation, vehicle speed, compressor pressure, and ambient temperature, which may be expressed in FIG. 3.

Therefore, the present disclosure enables the temperature of the compressor installed in a vehicle to be appropriately estimated using the compressor temperature estimate, ultimately allowing it to be used to prevent overheating of the compressor, thereby sufficiently ensuring the durability of the compressor while also reducing the manufacturing cost of the compressor assembly by eliminating the need for a temperature sensor.

In the calculating of the compressor state temperature estimate (S10), the compressor state temperature estimate is calculated by using the compressor state temperature estimate and the compressor pressure estimate as state variable estimates, taking the operating status of the compressor as an input, and using an estimator state equation that adds a compressor pressure estimation error.

The estimator state equation is expressed as \hat{\dot{x}}=A\hat{x}+Bu+L(y−ŷ). Here, the state variable is

$$x = [ \begin{matrix}{T}_{c} \\ P\end{matrix} ] ,$$

the state variable estimate is

$$\hat{x} = [ \begin{matrix}{\hat{T}}_{c} \\ \hat{P}\end{matrix} ] ,$$

the time derivative of state variable estimate is

$$\dot{\hat{x}} = \frac{d \hat{x}}{dt} ,$$

T_{c} is the compressor state temperature, \hat{T}_{c} is the compressor state temperature estimate, P is the compressor pressure, \hat{P} is the compressor pressure estimate, u is the compressor operation signal, y=P, ŷ=\hat{P}, (y−ŷ) is compressor pressure estimate error, system matrix is

$$A = [ \begin{matrix}{a}_{1} + {a}_{2} {V}_{s} & {a}_{3} \\ {a}_{4} & {a}_{5}\end{matrix} ] ,$$

input matrix is

$$B = [ \begin{matrix}{b}_{1} \\ {b}_{2}\end{matrix} ] ,$$

Vₛ is vehicle speed, and L is estimate gain.

The compressor pressure P is obtained by a pressure sensor 13 configured to measure the pressure at an outlet side of the compressor.

That is, characteristic parameters a1, a2, a3, a4, and a5 of the system matrix A and characteristic parameters b1 and b2 of the input matrix B are set to values that minimize a model error [temperature sensor temperature-compressor temperature estimate] by using a compressor temperature model below:

$$emperature model = \{ \begin{matrix}[ \begin{matrix}{\dot{T}}_{c} \\ \dot{P}\end{matrix} ] = [ \begin{matrix}{a}_{1} + {a}_{2} {V}_{s} & {a}_{3} \\ {a}_{4} & {a}_{5}\end{matrix} ] [ \begin{matrix}{T}_{c} \\ P\end{matrix} ] + [ \begin{matrix}{b}_{1} \\ {b}_{2}\end{matrix} ] u \\ {T}_{e} = {T}_{c} + {T}_{o} \\ {\hat{T}}_{e} = {\hat{T}}_{c} + {\hat{T}}_{o} \\ y = P\end{matrix}$$

Here, Tₑ is the compressor temperature=temperature sensor temperature, \hat{T}ₑ is the compressor temperature estimate, and Tₒ is the ambient temperature.

That is, the system matrix A and the input matrix B are obtained by determining the characteristic parameters through multiple experiments and analyses with a temperature sensor installed on the compressor.

As a reference, the characteristic parameters may be searched using optimization methods such as the least square method or the simplex method.

The characteristic parameter a2 of the system matrix A is set to a negative value to reflect the temperature decrease of the compressor according to the vehicle speed, and a1 is set to reflect the temperature decrease of the compressor when the vehicle is stationary.

That is, when the characteristic parameter a2 is set to a negative value, it expresses that the compressor state temperature decreases at a faster rate as the vehicle speed Vs increases, and when the vehicle speed Vs reaches zero, it expresses that the compressor state temperature decreases in a stationary state by a1.

Meanwhile, it is preferable to classify the estimation gains L into four types according to the state of the compressor and to use a separate estimation gain for each state.

That is, depending on the state of the compressor, the influence of the compressor pressure estimation error on the compressor state temperature varies, which allows for a more accurate estimation of the compressor state temperature by reflecting the variation.

The four states of the compressor that uses the classified estimation gains may be classified as follows: a state in which the compressor is driven to store compressed air in the reservoir 5; a state in which the operation of the compressor is stopped after storing compressed air in the reservoir 5, causing the compressor temperature to drop; a state in which the compressor is driven to supply compressed air to a load; and a state in which the supply of compressed air to the load is completed and the operation of the compressor is stopped, causing the compressor temperature to drop.

Here, the load that receives the compressed air from the compressor may be the air springs 3 of the air suspension or the like.

That is, it aims to distinguish between a state in which the compressed air produced by the compressor 1 is supplied to the air springs 3 and a state in which the compressed air is supplied to the reservoir 5, and distinguish between a state in which the operation of the compressor 1 is stopped after the compressed air is supplied to the air springs 3 and a state in which the operation of the compressor 1 is stopped after the compressed air is supplied to the reservoir 5.

Of course, the estimation gains may also be set for each state through multiple experiments and analyses.

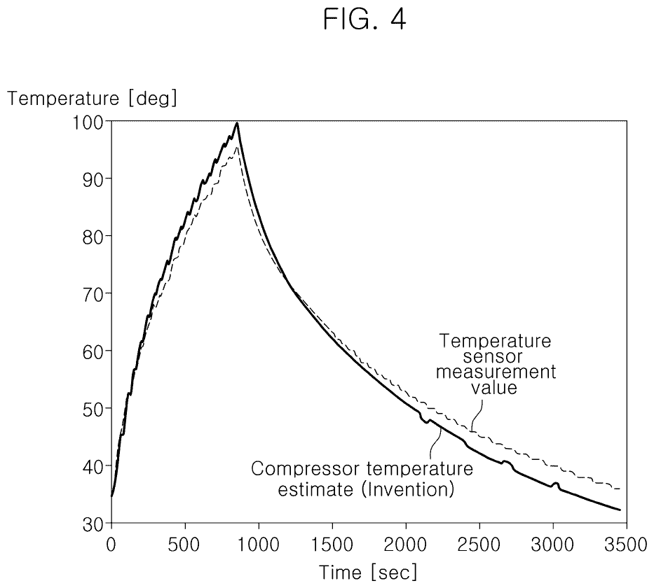

FIG. 4 is a graph comparing compressor temperature estimates obtained by the present disclosure with actual measurements by a temperature sensor. Based on this, it can be confirmed that the compressor temperature estimates according to the present disclosure are very similar to the temperature sensor measurements.

Meanwhile, the controller 21 may be configured to restrict the driving of the compressor 1 when the compressor temperature estimate, determined by the method described above, exceeds a predetermined reference temperature.

The reference temperature is appropriately set through experiments and analyses to a level that does not reduce the durability of the compressor and the motor 7 due to overheating. Thus, the controller 21 compares the compressor temperature estimate to the reference temperature, and when it becomes difficult to sufficiently ensure the durability of the compressor 1, the controller 21 can restrict the operation of the compressor 1 and the motor 7, thereby appropriately protecting the compressor 1 and the motor 7.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. A method for estimating a compressor temperature of a compressor, comprising:
defining a difference between the compressor temperature and an ambient temperature as a compressor state temperature;
calculating, by a controller, a compressor state temperature estimate based on an operating status of the compressor, a vehicle speed, and a compressor pressure; and
calculating, by the controller, a compressor temperature estimate by adding the ambient temperature to the compressor state temperature estimate,
limiting an operation of the compressor, by the controller, when the compressor temperature estimate estimated exceeds a predetermined reference temperature.

2. The method of claim 1, wherein calculating the compressor state temperature estimate comprises:
calculating the compressor state temperature estimate by using the compressor state temperature estimate and a compressor pressure estimate as state variable estimates;
taking the operating status of the compressor as an input; and
using an estimator state equation that adds a compressor pressure estimation error.

3. The method of claim 2, wherein the estimator state equation is expressed as \hat{\dot{x}}=A\hat{x}+Bu+L(y−ŷ), wherein a state variable is
$$x = [ \begin{matrix}{T}_{c} \\ P\end{matrix} ] ,$$
the state variable estimate is
$$\hat{x} = [ \begin{matrix}{\hat{T}}_{c} \\ \hat{P}\end{matrix} ] ,$$
a time derivative of the state variable estimate is
$$\dot{\hat{x}} = \frac{d \hat{x}}{dt} ,$$
T_{c} is the compressor state temperature, \hat{T}_{c} is the compressor state temperature estimate, P is the compressor pressure, \hat{P} is the compressor pressure estimate, u is a compressor operation signal, y=P, ŷ=\hat{P}, (y−ŷ) is a compressor pressure estimate error, a system matrix is
$$A = [ \begin{matrix}{a}_{1} + {a}_{2} {V}_{s} & {a}_{3} \\ {a}_{4} & {a}_{5}\end{matrix} ] ,$$
an input matrix is
$$B = [ \begin{matrix}{b}_{1} \\ {b}_{2}\end{matrix} ] ,$$
Vₛ is the vehicle speed, and L is an estimate gain, and
wherein the compressor pressure P is obtained by a pressure sensor configured to measure the pressure at an outlet side of the compressor.

4. The method of claim 3, wherein characteristic parameters a1, a2, a3, a4, and a5 of the system matrix A and characteristic parameters b1 and b2 of the input matrix B are set to values that minimize a model error [temperature sensor temperature-compressor temperature estimate] by using a compressor temperature model below:
$$Temperature model = \{ \begin{matrix}[ \begin{matrix}{\dot{T}}_{c} \\ \dot{P}\end{matrix} ] = [ \begin{matrix}{a}_{1} + {a}_{2} {V}_{s} & {a}_{3} \\ {a}_{4} & {a}_{5}\end{matrix} ] [ \begin{matrix}{T}_{c} \\ P\end{matrix} ] + [ \begin{matrix}{b}_{1} \\ {b}_{2}\end{matrix} ] u \\ {T}_{e} = {T}_{c} + {T}_{o} \\ {\hat{T}}_{e} = {\hat{T}}_{c} + {\hat{T}}_{o} \\ y = P\end{matrix} ,$$
wherein Tₑ is the compressor temperature=temperature sensor temperature, Tₑ is the compressor temperature estimate, and Tₒ is the ambient temperature.

5. The method of claim 4, wherein the characteristic parameter a2 of the system matrix A is set to a negative value to reflect a temperature decrease of the compressor according to the vehicle speed, and a1 is set to reflect the temperature decrease of the compressor when the vehicle is stationary.

6. The method of claim 3, wherein the estimate gain L is classified into one of four different categories based on a state of the compressor, and a separate estimate gain is used for each state.

7. The method of claim 6, wherein the four states of the compressor comprise:
a first state in which the compressor is operated to store compressed air in a reservoir;
a second state in which the compressor stops operating after storing the compressed air in the reservoir, and the compressor temperature decreases;
a third state in which the compressor is operated to supply the compressed air to a load; and
a fourth state in which the compressor stops operating after supplying the compressed air to the load, and the compressor temperature.

8. The method of claim 7, wherein the load supplied with the compressed air from the compressor comprises an air spring of an air suspension.

9. A vehicle compressor controller configured to calculate the compressor temperature estimate by the method of claim 1.
